(19) United States
(12) Patent Application Publication
(10) Pub. No.: US 2010/0163174 A1
(43) Pub. Date: Jul. 1, 2010

(54) PROCESS AND APPARATUS FOR PRODUCING COMPOSITE STRUCTURES

(75) Inventors: David Patrick Calder, Baltimore, MD (US); Graham Frank Howarth, Middletown, MD (US)

Correspondence Address: HARTMAN AND HARTMAN, P.C., 552 EAST 700 NORTH, VALPARAISO, IN, 46383, US

(73) Assignee: MRA SYSTEMS, INC., Baltimore, MD (US)

(21) Appl. No.: 12/345,704

(22) Filed: Dec. 30, 2008

(51) Int. Cl. B32B 37/10

(52) U.S. Cl. 156/285; 156/513

(57) ABSTRACT

A process and apparatus for producing perforated composite structures, such as acoustic skins suitable for aircraft engine nacelle components. The process includes placing at least one mat member, a non-impregnated fabric member, and a pad member on a tool surface so that pins disposed on the mat member project through the fabric member to define holes therein, the fabric member is between the mat and pad members, and the mat, fabric and pad members yield a non-impregnated stack that conforms to the tool surface. The fabric member is then infused with a resin to yield a resin-impregnated fabric and the resin within the resin-impregnated fabric is partially cured, after which the partially-cured resin-impregnated fabric is removed from the tool surface and from between the mat and pad members. A post cure of the partially-cured resin-impregnated fabric can then be performed to yield the composite structure with the holes.

### BACKGROUND OF THE INVENTION

The present invention generally relates to molding processes and equipment for producing composite articles. More particularly, this invention relates to a molding process for producing perforated composite structures suitable for use in, as examples, nacelle components and acoustic panels of gas turbine engines.

A typical construction used in aircraft engine nacelle components and other aerostructures is a sandwich-type layered structure comprising a core material between a pair of thinner sheets or skins. The core material is typically a lightweight material, often a foam or honeycomb metallic or composite material. A variety of metallic and composite materials can also be used for the skins, with common materials including aluminum alloys, fiberglass, and fabric materials (for example, a graphite fabric) impregnated with resin (for example, an epoxy resin).

A conventional process for producing composite skins is to impregnate a graphite fabric with resin and then precure the impregnated skin. Pre-impregnated skins are bonded to opposite surfaces of a core material with adhesive under pressure and heat, typically performed in an autoclave, during which final curing occurs. Alternative conventional processes include co-curing where the skins are not pre-cured but are cured as part of the process of curing the adhesive to skin bond. Disadvantages associated with these processes include long cycle times, high capital investment, and difficulty when attempting to implement for complex geometries. Alternative processes for producing layered composite structures do not employ curing in an autoclave. Examples include resin transfer molding (RTM) and vacuum-assisted resin transfer molding (VARTM).

Skins used to form nacelle components (such as the engine inlet, thrust reverser cowls, and blocker doors) and engine duct flow surfaces are acoustically treated by forming numerous small through-holes that help to suppress noise by channeling pressure waves associated with sound into the open cells within the core, where the energy of the waves is dissipated through friction (conversion to heat), pressure losses, and cancellation by wave reflection. For some gas turbine engine applications, perforations on the order of about 0.03 to about 0.06 inch (about 0.75 to about 1.5 mm) in diameter and hole-to-hole spacings of about 0.06 to about 0.12 inch (about 1.5 to about 3 mm) are typical, resulting in acoustic hole patterns containing seventy-five holes or more per square inch (about twelve holes or more per square centimeter) of treated surface. Given the large number of holes necessary to acoustically treat nacelle components and acoustic panels, rapid and economical methods for producing the holes are desirable.

Common processes currently employed to produce acoustic holes in acoustic skins include punching, mechanical drilling, and pin molding. Each of these processes has its limitations. For example, punching is typically practical for only relatively thin skins of one or two plies, and is often limited to producing fiberglass acoustic skins. Mechanical drilling, which is often employed with graphite composite skins, typically drills one, two, or four holes at a time in a skin cured to its finished geometric shape. In addition to limited speed, mechanical drilling processes tend to be expensive due to the special tooling and machinery required to place the holes in the proper orientation on the contoured skin. Pin molding typically entails forcing a pre-impregnated composite skin material onto metallic or nonmetallic pin mats, after which the skin material undergoes an autoclave cure followed by removal of the pin mats. Such a process is slow and labor intensive with significant recurring costs arising from the need to replace worn pin mats. In addition, both mechanical drilling and forcing sharp pins through fibrous materials result in breakage of fibers and a reduction of optimum laminate skin strength. None of these processes are well suited for perforating composite skins at relatively high rates while incurring minimal equipment, labor, and recurring costs.

### BRIEF DESCRIPTION OF THE INVENTION

The present invention provides a process and apparatus for producing perforated composite structures, particular but nonlimiting examples of which include composite acoustic skins suitable for aircraft engine nacelle components, such as the engine inlet, thrust reverser cowls, and blocker doors, engine duct acoustic panels, surfaces that might be employed for aircraft surface skin laminar flow control, and a variety of other perforated layered structures.

According to a first aspect of the invention, the process includes placing at least one mat member, a non-impregnated fabric member, and a pad member on a tool surface so that pins disposed on the mat member project through the fabric member to define holes therein, the fabric member is between the mat and pad members, and the mat, fabric and pad members yield a non-impregnated stack that conforms to the tool surface. The fabric member is then infused with a resin to yield a resin-impregnated fabric member, the resin within the resin-impregnated fabric member is partially cured, and the partially-cured resin-impregnated fabric member is removed from the tool surface and from between the mat and pad members. A post cure of the freestanding partially-cured resin-impregnated fabric member can then be performed to yield the composite structure containing the holes original defined in the fabric member.

A second aspect of the invention is an apparatus that can be employed by the above process. The apparatus includes at least one mat member, a non-impregnated fabric member, and a pad member on a tool surface so that pins disposed on the mat member project through the fabric member, the fabric member is between the mat and pad members, and the mat, fabric and pad members yield a non-impregnated stack that conforms to the tool surface. The apparatus further includes means for infusing the fabric member with a resin to yield a resin-impregnated fabric member.

A significant advantage of this invention is the capability of producing a perforated composite structure by infiltrating a dry fabric member so that the composite structure and its perforations are simultaneously formed in essentially a single step, instead of requiring a post-cure punching, drilling, or other process to form the perforations. Another advantage is that the fabric member is not impregnated with resin at the time the pins of the mat member are introduced into the fabric member, enabling the pins to more easily slip through the fibrous construction of the fabric member and eliminating or at least significantly reducing the risk of broken fibers. Other advantages include the potential for reduced cycle times and significantly reduced capital equipment investment, including the ability to perform the curing process without an autoclave, the use of lower curing temperatures that allow the use of lower-cost tooling, and the use of relatively low-cost materials and structures for the mat and pad members.

Other aspects and advantages of this invention will be better appreciated from the following detailed description.

### BRIEF DESCRIPTION OF THE DRAWINGS

FIG. 1 is a perspective view of an inlet inner barrel of a type used for an aircraft engine nacelle.

FIG. 2 is a schematic exploded view showing a molding apparatus and a dry fabric member for producing an acoustic composite skin for the inlet inner barrel of FIG. 1.

FIG. 3 is a detailed view of an edge of the molding apparatus of FIG. 3 prior to performing a resin transfer molding process on the dry fabric material.

FIG. 4 represents processing steps performed to produce an acoustic composite skin with the apparatus of FIGS. 2 and 3.

### DETAILED DESCRIPTION OF THE INVENTION

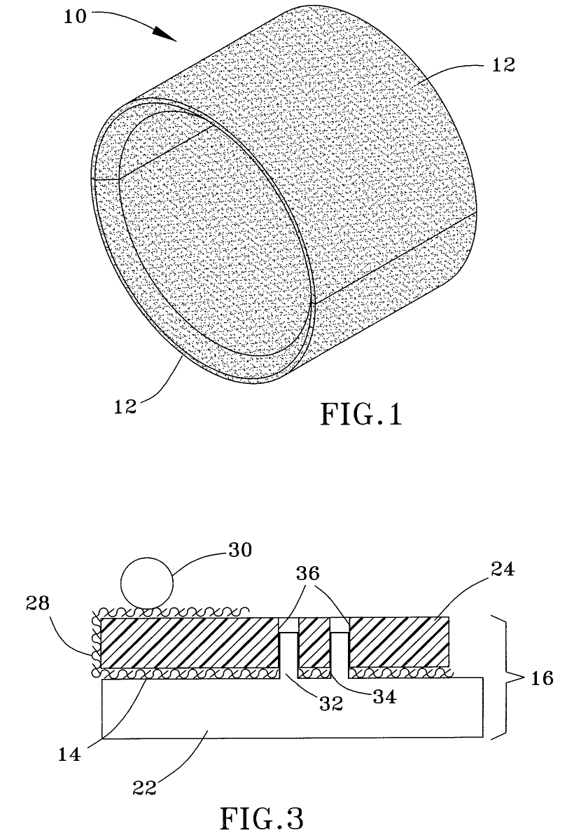

FIG. 1 is representative of a two-piece inlet inner barrel 10 for an aircraft engine nacelle. A typical construction for each half 12 of the inner barrel 10 includes a core layer disposed between a pair of metal or composite skins, with one or more additional layers also possible. According to a preferred aspect of the invention, at least one of the skins is an acoustic composite skin that can be produced using processing steps of the present invention. While the invention will be described in reference to the inlet inner barrel 10, it should be understood that the invention is applicable to a variety of components that might benefit from having a perforated composite component, including but not limited to other aircraft engine nacelle components (for example, thrust reverser cowls and blocker doors), engine duct acoustic panels, and a variety of other perforated layered structures.

The core layer of each half 12 of the barrel 10 may have a closed-cell or otherwise nonporous construction, or an open-cell or otherwise porous construction. Nonlimiting examples of the former include wood (for example, balsa wood) and other cellulosic materials, and closed-cell, low-density, rigid foam materials formed of polymethacrylimide and commercially available under the name ROHACELL® from Evonik Industries (formerly Degussa). Nonlimiting examples of open-cell or porous core layers include open-cell ceramic, metal, carbon and thermoplastic foams and honeycomb-type materials formed of, for example, NOMEX® aramid fibers. Such core materials and constructions are well known in the art, and therefore will be discussed in any detail.

The conventional state of the art for composite skins of the type used in the barrel 10 is a resin-impregnated fabric. Prior to impregnation with resin, the fabric may be referred to as a “dry” fabric, and typically comprises a stack of two or more fiber layers (plies) and a scrim cloth. While conventional practice has been to resin-impregnate the fabric prior to performing an acoustic treatment by which the resin-impregnated fabric is perforated, composite skins produced by this invention undergo perforation simultaneously with the resin-impregnation process, as discussed below.

The fiber layers and scrim cloth of dry fabrics that can be used with this invention may be formed of a variety of materials, nonlimiting examples of which include carbon (e.g., graphite), glass (e.g., fiberglass), polymer (e.g., Kevlar®), and ceramic (e.g., Nextel®) fibers. Suitable individual thicknesses for the fiber layers will depend on the particular application of the composite structure being produced. In the case of the inlet inner barrel 10 of FIG. 1, a typical individual thickness for the fiber layers is about 0.2 to about 0.4 millimeters, and a typical thickness for the dry fabric stack is about 1.3 to about 2.5 millimeters, though much lesser and greater thicknesses are also foreseeable.

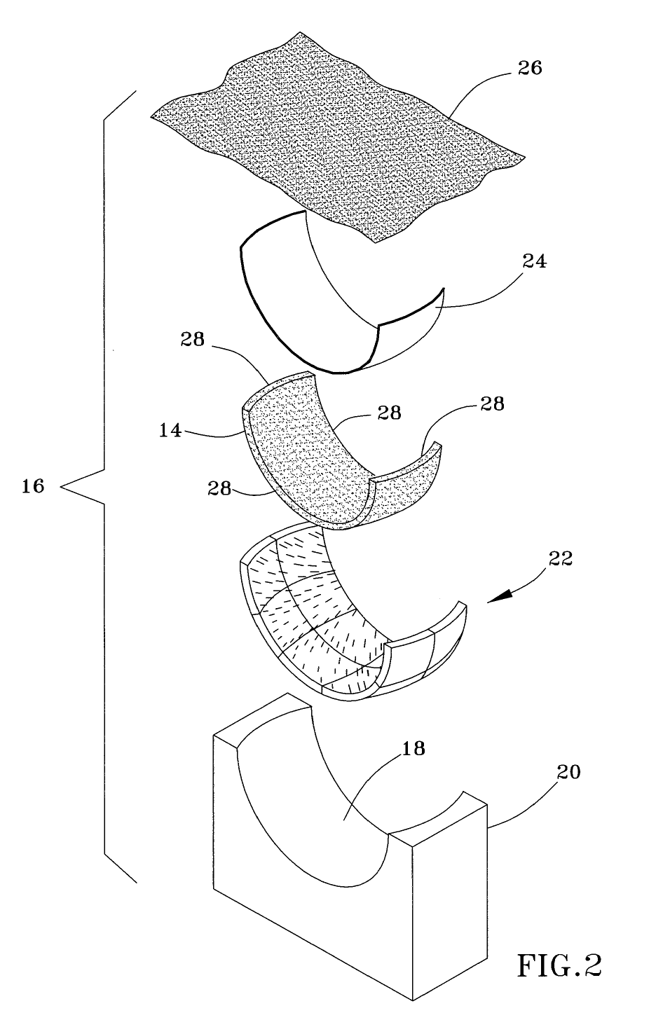

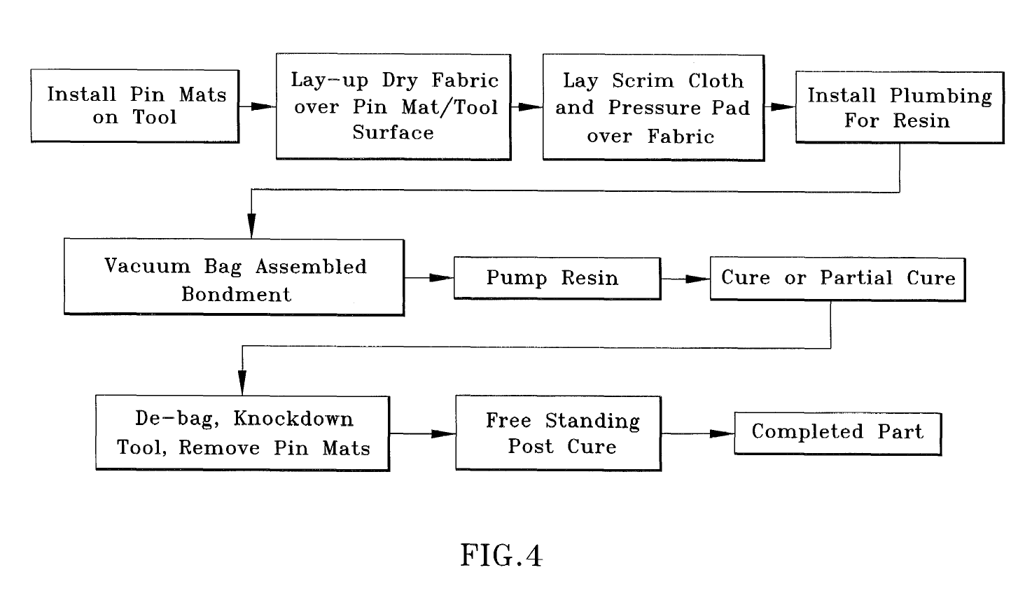

FIGS. 2 and 3 schematically represent a dry fabric 14 of a type described above for an acoustic composite skin of this invention, and FIG. 4 is a flow chart for a vacuum-assisted resin transfer molding (VARTM) process by which, according to a particularly preferred aspect of the invention, acoustic holes 34 can be formed in the dry fabric 14 during infiltration of the fabric 14 with a resin. As known in the art, a wide variety of polymeric materials can be chosen as the resin used to infiltrate the dry fabric 14. The principal role of the resin is to form a matrix material for the fibrous material within the dry fabric 14, and as such the resin contributes to the structural strength and other physical properties of the composite skin produced from the dry fabric 14. Therefore, the resin should be compositionally compatible with the dry fabric 14. Additionally, because the resin will usually contact other layers, such as the core layers of the barrel 10, the resin will usually be chosen for compositional compatibility with the materials of the core layers and, if present, any additional layers of the barrel 10 that the resin may contact. The resin must also be capable of curing under temperature conditions that will not thermally degrade or otherwise be adverse to the materials of the dry fabric 14 and core layer. On this basis, particularly suitable resins materials are believed to include epoxies, with curing temperatures typically below 200° C., for example, about 190° C.

FIG. 2 schematically represents the dry fabric 14 as part of a stack 16 placed on a tool surface 18 of a tool 20 suitable for resin-infiltrating the fabric 14 to produce an acoustic composite skin for one half 12 of the two-piece inner barrel 10 of FIG. 1. Included in the stack 16 are multiple pin mats 22 and a pressure pad 24. The pin mats 22 are represented as being placed directly on the tool surface 18, followed by the dry fabric 14 and then the pressure pad 24. The fabric 14, mats 22 and pressure pad 24 are sufficiently pliable so that, when placed on the tool 20, the entire stack 16 conforms to the surface 32 of the tool 20. Other possible components of the molding apparatus will depend on the technique used to resin-infiltrate the dry fabric 14 and cure the resulting resin-impregnated acoustic composite skin. For example, in the preferred embodiment in which a VARTM process is used, the stack 16 is preferably covered by an air-impermeable bag 26 to enable a vacuum to be drawn between the tool surface 18 and the bag 26, such that the bag 26 is able to compress the fabric 14 between the mats 22 and pressure pad 24 and resin will be drawn into and infiltrate the fabric 14.

The mats 22 have pins 32 that project from their upper surfaces. The pins 32 are intended to form the desired acoustic holes 34 for the acoustic composite skin, and therefore must be of sufficient length to completely penetrate the dry fabric 14 and may protrude into the pressure pad 24 (FIG. 3). Furthermore, the pins 32 are preferably in a well-defined pattern and have diameters chosen to produce the desired diameters for the acoustic holes 34, for example, on the order of about 0.03 to about 0.06 inch (about 0.75 to about 1.5 mm) with a hole-to-hole spacing of about 0.06 to about 0.12 inch (about 1.5 to about 3 mm). Other hole sizes and spacings are foreseeable and therefore also within the scope of the invention. In order to penetrate the fabric 14, the mats 22 and their pins 32 are preferably formed of a material that is relatively rigid in comparison to the fabric 14, yet allow the mats 22 to conform to some degree to the tool surface 18. To minimize recurring costs for the molding process, a nonlimiting example of a particularly suitable material for the mats 22 and pins 32 is polyethylene terephthalate (PET), and a particularly suitable construction for the mats 22 and pins 32 is an injection molding that yields mats 22 having integrally-formed pins 32 and a contoured shape that approximately conforms to the tool surface 18, though other materials and constructions are also within the scope of the invention. Multiple pin mats 22 are preferred over a single mat to facilitate removal of the mat 22 following resin-infiltration of the fabric 14 and, because of their relative rigidity, conformance to the tool surface 18, though the use of a single pin mat is also within the scope of the invention.

To enable the pressure pad 24 to be readily penetrated by the pins 32, suitable materials for the pad 24 include elastomeric materials, including synthetic rubbers. The pressure pad 24 can be preformed to optionally have apertures 36 that are complementary in size and location to the pins 32 of the mats 22, so that the apertures 36 receive the pins 32 and provide a mechanical locating and locking capability to ensure an arrangement of the mats 22 that will yield a uniform placement of the pins 32 and the resulting acoustic holes 34.

According to a particular aspect of the invention, the fabric 14 maybe larger than the pressure pad 24 and the combined size of the pin mats 22 so that, as represented in FIG. 3, at least one edge 28 and preferably two or more edges 28 of the fabric 14 protrude from between the mats 22 and pad 24. As such, resin can be applied to the exposed edge(s) 28 and then drawn into the fabric 14 under the effect of a vacuum. As represented in FIG. 3, an edge 28 at which resin is applied is preferably wrapped over the adjacent edge of the pressure pad 24, and a line 30 through which the vacuum is drawn and/or resin is applied is placed directly on the edge 28 of the fabric 14. For example, about two inches (about five centimeters) of the fabric 28 may overlie the edge of the pressure pad 24. Once the resin has been delivered through the line 30 to thoroughly infiltrate the dry fabric 14, the resulting resin-impregnated fabric can be heated on the tool 20 to a temperature and for a duration sufficient to partially cure the resin. The infiltration/impregnation and curing temperatures, pressure/vacuum levels, and other parameters of the infiltration and curing cycles will depend on the particular materials used, and can be determined by routine experimentation.

FIG. 4 is a flow chart more particularly identifying individual steps performed when employing a VARTM technique to produce acoustic composite skins with the apparatus of FIGS. 2 and 3. More particularly, FIG. 4 represents the VARTM process as comprising the installation of the pin mats 22 on the surface 18 of the tool 20, laying-up the dry fabric 14 on the mats 22, and applying an optional scrim cloth (not shown) and the pressure pad 24 and on the dry fabric 14 as indicated in FIG. 2. The resin/vacuum lines 30 are then installed (FIG. 3), after which the vacuum bag 26 is applied to the stack 16, a vacuum is drawn, and then resin is pumped into the stack 16 to achieve infiltration of the fabric 14, during which the desired acoustic holes 34 for the composite skin are molded in-situ around the mat pins 32. Thereafter, the resin-infiltrated fabric can be partially cured while remaining in the stack 16, after which the bag 26 is removed, the stack 16 is removed from the tool 20, and the mats 22 and pressure pad 24 are removed from the partially-cured resin-infiltrated fabric. A post cure can then be performed on the freestanding partially-cured resin-infiltrated fabric to yield an acoustic composite skin. The process represented in FIG. 4 has been successfully completed on test components formed on candidate materials for acoustic composite skins, as well as specimens of acoustic composite skins.

In view of the above, it can be appreciated that a composite skin and its acoustic holes 34 can be formed simultaneously by infiltration of the dry fabric 14 in essentially a single step, instead of being pre-impregnated with a resin, cured, and then undergoing punching or drilling or being forced onto a pinned mat prior to autoclaving. Other processing advantages include the relatively lowcost tooling made possible with the pin mats 22 and pressure pad 24 and the elimination of an autoclaving cure step. The mats 22 and pad 24 can be replaced as needed at minimal cost, and the VARTM process reduces cycle time and allows for the use of low viscosity resins that readily flow at room temperature and cure at relatively low temperatures. An additional advantage is the quality of the acoustic holes 34 produced by the molding process as a result of avoiding damage and exposure of fibers within the fabric 14, and the creation of resin-rich hole walls that promote moisture sealing.

While the invention has been described in terms of specific embodiments, it is apparent that other forms could be adopted by one skilled in the art. For example, the physical configuration of the composite skin could differ from that described, and materials and processes other than those noted could be used. Therefore, the scope of the invention is to be limited only by the following claims.

1. A process of producing a composite structure comprising a resin-impregnated fabric, the process comprising:
placing at least one mat member, a non-impregnated fabric member, and a pad member on a tool surface so that pins disposed on the mat member project through the non-impregnated fabric member to define holes therein, the non-impregnated fabric member is between the mat member and the pad member, and the mat member, the non-impregnated fabric member, and the pad member yield a non-impregnated stack that conforms to the tool surface;
infusing the non-impregnated fabric member with a resin to yield a resin-impregnated fabric;
partially curing the resin within the resin-impregnated fabric;
removing the partially-cured resin-impregnated fabric from the tool surface and from between the mat member and the pad member; and then
performing a post cure of the partially-cured resin-impregnated fabric to yield the composite structure comprising the holes.

2. The process according to claim 1, wherein the placing step comprises:
placing the mat member on the tool surface so that the pins thereof project away from the tool surface; and
applying the non-impregnated fabric member to the mat member and forcing the pins of the mat member through the non-impregnated fabric member.

3. The process according to claim 1, wherein the mat member is one of a plurality of mats comprising pins.

4. The process according to claim 1, wherein the mat member is formed of a polymeric material.

5. The process according to claim 1, wherein the mats and the pins thereof are more rigid than the non-impregnated fabric member.

6. The process according to claim 1, wherein the pad member is formed of an elastomeric material.

7. The process according to claim 1, wherein the pad member comprises apertures therein that are complementary in size and location to the pins of the mat member.

8. The process according to claim 1, wherein the placing step results in an edge of the non-impregnated fabric member protruding from between the mat member and the pad member, and the infusing step comprises applying the resin to the protruding edge of the non-impregnated fabric member.

9. The process according to claim 1, wherein the infusing step comprises applying a vacuum to draw the resin through the non-impregnated fabric member.

10. The process according to claim 1, wherein the composite structure is an acoustic composite skin.

11. The process according to claim 12, further comprising placing a core layer between the acoustic composite skin and a second skin to form a component of an aircraft nacelle.

12. A process of producing an acoustic composite skin for a component of an aircraft nacelle, the process comprising:
placing a plurality of mats on a tool surface so that pins disposed on each of the mats project away from the tool surface;
applying a non-impregnated fabric member to the mats and forcing the pins of the mats through the non-impregnated fabric member to define holes therein;
applying a pad member to the non-impregnated fabric member such that the non-impregnated fabric member is between the mats and the pad member, the mats, the non-impregnated fabric member, and the pad member yield a non-impregnated stack that conforms to the tool surface, and an edge of the non-impregnated fabric member protrudes from between the mats and the pad member;
applying a resin to the protruding edge of the non-impregnated fabric member;
applying a vacuum to draw the resin through the non-impregnated fabric member and yield a resin-impregnated fabric;
partially curing the resin within the resin-impregnated fabric;
removing the partially-cured resin-impregnated fabric from the tool surface and from between the mats and the pad member; and then
performing a post cure of the partially-cured resin-impregnated fabric to yield the acoustic composite skin comprising the holes.

13. An apparatus for producing a composite structure comprising a resin-impregnated fabric, the apparatus comprising:
at least one mat member, a non-impregnated fabric member, and a pad member on a tool surface so that pins disposed on the mat member project through the non-impregnated fabric member to define holes therein, the non-impregnated fabric member is between the mat member and the pad member, and the mat member, the non-impregnated fabric member, and the pad member yield a non-impregnated stack that conforms to the tool surface; and
means for infusing the non-impregnated fabric member with a resin to yield a resin-impregnated fabric.

14. The apparatus according to claim 13, wherein the mat member is one of a plurality of mats comprising pins.

15. The apparatus according to claim 13, wherein the mat member is formed of a polymeric material.

16. The apparatus according to claim 13, wherein the mats and the pins thereof are more rigid than the non-impregnated fabric member.

17. The apparatus according to claim 13, wherein the pad member is formed of an elastomeric material.

18. The apparatus according to claim 13, wherein the pad member comprises apertures therein that are complementary in size and location to the pins of the mat member.

19. The apparatus according to claim 13, wherein an edge of the non-impregnated fabric member protrudes from between the mat member and the pad member to provide a location for applying the resin to the non-impregnated fabric member.

20. The apparatus according to claim 13, further comprising means for applying a vacuum to draw the resin through the non-impregnated fabric member.
